(19) United States
(12) Patent Application Publication
(10) Pub. No.: US 2009/0322123 A1
(43) Pub. Date: Dec. 31, 2009

(54) FRONT VEHICLE BODY STRUCTURE

(75) Inventors: Katsutoshi Tanaka, Hiroshima (JP); Yasuyuki Andou, Hiroshima (JP); Kouichi Nakano, Hiroshima (JP); Shiro Nakatani, Hiroshima (JP); Yukio Nakamura, Hiroshima (JP); Takao Maruko, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/490,974

(22) Filed: Jun. 24, 2009

(30) Foreign Application Priority Data
Jun. 26, 2008 (JP) 2008-167286
Jun. 26, 2008 (JP) 2008-167287
Jun. 26, 2008 (JP) 2008-167288
Jun. 26, 2008 (JP) 2008-167289
Jun. 26, 2008 (JP) 2008-167290

(51) Int. Cl. B60K 28/00

(52) U.S. Cl. 296/203.02

(57) ABSTRACT

A single wire is provided between a pair of front side frames and a power plant, respective front ends of which are coupled to front end portions of the pair of front side frames. Accordingly, the impact load can be dispersed to the both-side front side frames in case the central portion of the vehicle front collides with the pole-shaped obstacle and the power plant can be suppressed from moving rearward.

### BACKGROUND OF THE INVENTION

The present invention relates to a front vehicle body structure, and in particular relates to a front vehicle body structure which can improve the safety of a vehicle when a central portion of a vehicle front collides with a pole-shaped obstacle.

In general, a front portion of a vehicle body has a structure in which a bumper reinforcement which extends in a vehicle width direction is connected to a pair of front side frames at it both-side end portions, specifically, via crash cans. That is, the front vehicle body structure, in which the pair of front side frames functions as an impact absorbing member against the frontal collision of the vehicle, has been used.

Herein, the safety test against the vehicle frontal collision has been conducted in two manners. One is for a full-lap frontal collision, and the other is for an offset frontal collision. In the full-lap frontal collision test, the vehicle is made collide with a concrete wall obstacle at a specified speed. In the offset frontal collision test, one side portion of the vehicle (with a 40% overlap ratio) is made collide with a honeycomb-shaped wall obstacle.

Automotive companies have their own standards for the above-described full-lap and offset frontal collision tests, and they have been developed vehicles according to the standards.

There are various manners in the actual frontal-collision accidents. One example is a case in which the vehicle collides with an electric pole, a road-sign pole or the like which are provided at a road side. In case the side portion of the vehicle collides with such a pole-shaped obstacle from the vehicle front, the collision impact may be absorbed by one of the front side frames, like the above-described offset frontal collision test. In case the central portion of the vehicle front crashes against the pole-shaped obstacle, however, the bumper reinforcement may bends at its center because of its weak strength. Consequently, the both-side front side frames may not function properly, so that there is a concern that a large damage would be caused.

Japanese Patent Laid-Open Publication No. 2005-262951 discloses an impact load dispersing device which uses a tension maintaining mechanism with a compressive spring stored therein and a wire. This impact load dispersing device may function effectively for a relatively light collision in case of the full-lap frontal collision.

### SUMMARY OF THE INVENTION

An object of the present invention is to provide a front vehicle body structure which can properly disperse the impact load to the both-side front side frames in case the central portion of the vehicle front collides with the pole-shaped obstacle and suppress a power plant from moving rearward.

According to the present invention, there is provided a front vehicle body structure, comprising a power plant provided in an engine room, a pair of front side frames provided at both sides of a vehicle body, which extends in a longitudinal direction of the vehicle body, and a flexible tension member provided between the pair of front side frames and the power plant, respective front ends of which are coupled to front end portions of the pair of front side frames.

FIGS. 1 through 4 are diagrams which explain the basic idea of the present invention. In these figures, reference numeral 201 denotes an engine room at a front vehicle body. The engine room 201 is partitioned from a vehicle compartment by a dash panel 202. In the engine room 201, there is provided a power plant 208 which comprises a multi-cylinder reciprocating engine 205, an automatic transmission 206, and a deferential gear 207, for example. An output of the power plant 208 is distributed to both front wheels 209 via the differential gear 207. Herein, a so-called lateral disposition type of engine, in which an output shaft 205a of the engine 205 extends in a vehicle width direction, is shown in the figures. However, the present invention is applicable to a so-called longitudinal disposition type of engine, in which the output shaft 205a of the engine 205 extends in a longitudinal direction, or a four-wheel drive type of vehicle as well.

A pair of front side frames 210 is disposed on both (right and left) sides of the engine room 201 so as to extend in the longitudinal direction. The power plant 208 is mounted at the front side frames 210 directly or indirectly. A bumper reinforcement 212 is fixed to front ends of the front side frames 210 via crash cans 211. The bumper reinforcement 212 extends in the vehicle width direction as known.

A wire 215, as a flexible tension member, is fixed to the front side frames 210 at its front end portions. The wire 215 is provided between the pair of front side frames 210 and the power plant 208. In other words, the wire 215 extends forward from both sides of the power plant 208 in a plan view, and the front ends of the wire 215 are fixed to front end portions of the front side frames 210. Herein, the “front end portion” of the front side frame according to the present invention means a “specified portion” of the front side frame which is positioned in front of the power plant 208 and provides an enough crash of the front side frame 210 in its axial direction at the vehicle frontal collision (full-overlap collision, offset collision), and thereby it is not necessarily limited to a portion near the front end of the front side frame 210.

This wire 215 may be comprised of a single wire which extends behind the power plant 208 (FIG. 1). Or, as shown in FIGS. 2 and 3, the wire may be comprised of two split wires 215a, 215b which are positioned on both sides of the power plant 208. Herein, respective rear ends of the right and left split wires 215a, 215b may be coupled to elements 216, such as eye bolts fixed to the power plant 208, fixing tools fixed with bolts, fixing portion integrally formed at the power plant 208, or mount members 218 which mount the power plant 208 at the front side frames directly or indirectly. In case of an indirect mount, the mount member may be configured to mount the power plant 218 at a sub frame which is attached to the front side frames 210. Of course, one of the split wires 215a, 215b may be coupled to the fixing element 216, and the other may be coupled to the mount member 218.

In the above-described examples, at the vehicle frontal collision, in particular, when the central portion of the vehicle front collides with a pole-shaped obstacle P which has a relatively narrow width, the pole P comes into the engine room 201 and pushes the power plant 208 rearward. Herein, since the wire 215 is provided between the pair of front side frames 210 and the power plant 208, the impact load from the pole P can be properly dispersed to the both-side front side frames 210 via the wire 215. Further, since the input position of the impact load to the front side frames 210 via the wire 215 is located at the specified portion which is positioned in front of the power plant 208 and provides the enough crash of the front side frame 210 in its axial direction as described above, the shock absorbing function of the front side frames 210 can be achieved properly. Moreover, since the wire suppresses the power plant 208 from moving rearward, the power plant 208 can be properly prevented from coming into a vehicle compartment 203.

The wire 215 may be comprised of two sets of wires which are respectively positioned on an upper side and a lower side of the vehicle body as shown in FIG. 4. Herein, the variation of how each wire is provided between the pair of front side frames 210 and the power plant 208 may be selectable from the above-described manners shown in FIGS. 1 through 3. Further, it may be preferable that an upper wire 215A be positioned at a level higher than an engine output shaft 205a so as to extend horizontally in the side view. This layout can properly suppress the power plant 208 from falling down rearward when the pole P hits the power plant 208. Meanwhile, it may be preferable that a lower wire 215B be positioned below the engine output shaft 205a so as to extend “in parallel” to an axis line of the front side frame 210 in the side view. Herein, the “in parallel” to the axis line of the front side frame 210 means a technical situation in which the impact load applied via the lower wire 215B is inputted into a crash direction of the front side frame 210 which has been designed. Thus, the meaning of this “in parallel” should not be construed from the geometrical sense. In some cases, the axis line of the front side frame is slightly curved in the side view. In this case, the manner of the layout of the wire in which the direction of extension of the lower wire 215B is identical to the direction of the efficient crash of the front side frame which can perform the effective shock absorption is covered by the meaning scope of the “in parallel” of the present invention.

A rotational move of the power plant 208 with its lower end moving rearward from its upper end may be suppressed by the disposition of the upper and lower wires 215A, 215B when the pole P hits against the power plant 208. Further, the lower wire 215B may be preferably disposed so as to extend at a lower face of the power plant 208 (FIG. 4).

The front end of the wire 215 may be preferably coupled to the front side frame 210 via a fixing tool such as a vertical bolt 218 which penetrates the frame 210 vertically. Further, in case the upper and lower wires 215A, 215B are provided, the upper wire 215A may be preferably coupled to an upper portion of the vertical bolt 218 which projects upward from an upper face of the front side frame 210, while the lower wire 215B may be preferably coupled to a lower portion of the vertical bolt 218 which projects downward from a lower face of the front side frame 210.

According to the present invention, by additionally providing the flexible tension member such as the wire 215, the safety against the frontal collision in which the central portion of the vehicle front collides with any obstacle like the pole P can be improved, without changing the basic structure of the vehicle body.

According to an embodiment of the present invention, at least one of the front ends of the flexible tension members is coupled to the front end portion of the front side frame via a long bolt which penetrates through the front end portion of the front side frame having a closed cross section. Thereby, the impact load which is transmitted to the front side frame via the tension member can be dispersed to upper and lower portions of the closed cross section of the front side frame. Accordingly, without causing any local breakage of the front end portion of the front side frame, the shock absorbing function of the front side frames with the original crash can be performed.

According to another embodiment of the present invention, the flexible tension member comprises two sets of flexible tension members which are respectively positioned on an upper side and a lower side of the vehicle body, each set of which is provided between the pair of front side frames and the power plant, respective front ends thereof are coupled to front end portions of the pair of front side frames, and the long bolt is provided so as to penetrate through at least one of the front end portions of the front side frames in such a manner that at least one side of the front ends of the upper-side positioned flexible tension member and the lower-side positioned flexible tension member are coupled to the front end portion of the front side frame via an upper portion of the long bolt and a lower portion of the long bolt, respectively, the upper potion of the long bolt projecting upward from an upper face of the front side frame, the lower portion of the long bolt projecting downward from a lower face of the front side frame. Thereby, any improper move of the power plant, in particular, the rearward rotation of the power plant including the lateral disposition type of engine, which may be caused by the upper and lower tension members when the pole-shaped obstacle comes into the engine room at the vehicle frontal collision and hits against the power plant, can be suppressed properly.

According to another embodiment of the present invention, at least one of the front ends of the flexible tension members has a ring-shaped terminal portion, and the long bolt is provided so as to penetrate through the ring-shaped portion and the front end portion of the front side frame, whereby at least one of the front ends of the flexible tension members is coupled to the front end portion of the front side frame via the long bolt. Thereby, the front end of the tension member can be coupled to the front side frame surely.

According to another embodiment of the present invention, the power plant comprises a multi-cylinder reciprocating engine, and the flexible tension member is positioned at a level which substantially corresponds to a specified portion between a crank case and a cylinder head of the engine. Thereby, the impact load via the flexible tension member can be inputted along the axis line of the front side frame, so that the impact load can be inputted in the crash direction of the front side frame properly.

Other features, aspects, and advantages of the present invention will become apparent from the following description which refers to the accompanying drawings.

### BRIEF DESCRIPTION OF THE DRAWINGS

FIG. 1 is a diagram showing an example which is covered by a basic idea of the present invention.

FIG. 2 is a diagram showing another example which is covered by the basic idea of the present invention.

FIG. 3 is a diagram showing further another example which is covered by the basic idea of the present invention.

FIG. 4 is a diagram showing further another example which is covered by the basic idea of the present invention in which two sets of upper and lower wires (flexible tension members) are disposed.

FIG. 5 is a view of an engine room according to a first embodiment, when viewed obliquely from above.

FIG. 6 is a view of the engine room according to the first embodiment, when viewed from side.

FIG. 7 is a perspective view showing an example according to the first embodiment, in which a front end of the wire has a single-lock terminal, and the front end of the wire is fixed to a front side frame via a long bolt for attaching a sub frame to the front side frame.

FIG. 8 is a view of a power plant according to the first embodiment, when viewed from rear, for explaining guide members to dispose upper and lower wires.

FIG. 9 is a view of an example of the guide member according to the first embodiment.

FIG. 10 is a view of another example of the guide member according to the first embodiment.

FIG. 11 is a side view of a modified embodiment of the first embodiment, in which the upper and lower wires are disposed in parallel to an axis line of the front side frame.

FIG. 12 is a view of an engine room according to a second embodiment, when viewed from above.

FIG. 13 is a view of the engine room according to the second embodiment, when viewed from side.

FIG. 14 is a view of the engine room according to the second embodiment, when viewed from below.

FIG. 15 is a view showing an example according to the second embodiment, in which a lower wire engages with a first mount member which mounts a rear portion of a power plant at a sub frame.

FIG. 16 is a view showing an example of a coupling method of a rear end of a lower split wire to the first mount member of FIG. 15.

FIG. 17 is a view showing the example of the coupling method of the rear end of the lower split wire to the first mount member of FIG. 16.

FIG. 18 is a view of an engine room according to a third embodiment, when viewed from above.

FIG. 19 is a view of the engine room according to the third embodiment, when viewed obliquely from rear.

FIG. 20 is a view of an engine room according to a fourth embodiment, when viewed from side.

FIG. 21 is a perspective view showing an example according to the fourth embodiment, in which a rear end of an upper split wire is coupled to a second mount member which mounts an end face of the lateral disposition type of engine of the power plant at the front side frame.

FIG. 22 is a sectional view taken along line X18-X18 of FIG. 21.

FIG. 23 is a view of the engine room according to a fifth embodiment, when viewed obliquely from front.

FIG. 24 is a view explaining an example according to the fifth embodiment, in which the power plant is mounted at the front side frame via a third engine mount member which is coupled to a bracket provided on an upper face of a transmission case of a transaxle of the power plant, and a rear end of the upper split wire is fixed with a bolt for fixing the bracket to the transmission case.

FIG. 25 is a view of an engine room according to a sixth embodiment, when viewed obliquely from above.

FIG. 26 is a view of the engine room according to the sixth embodiment, when viewed from side.

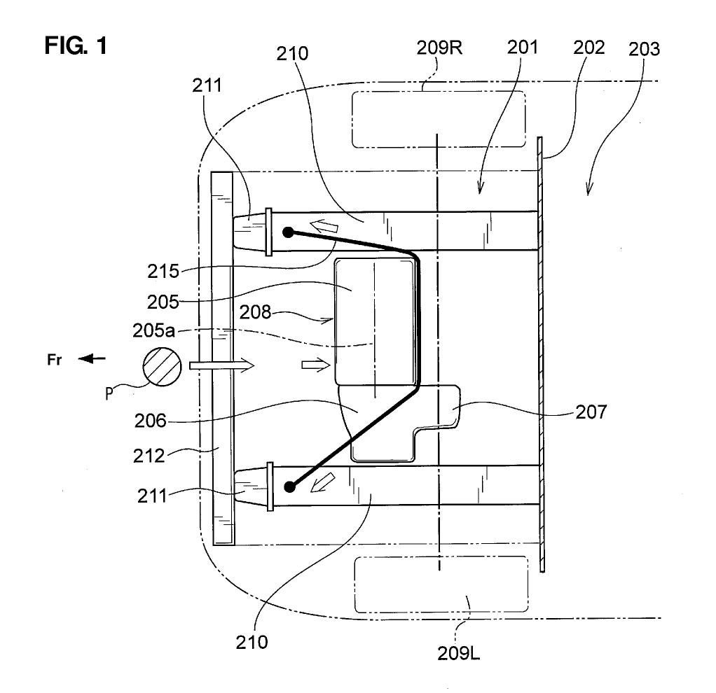

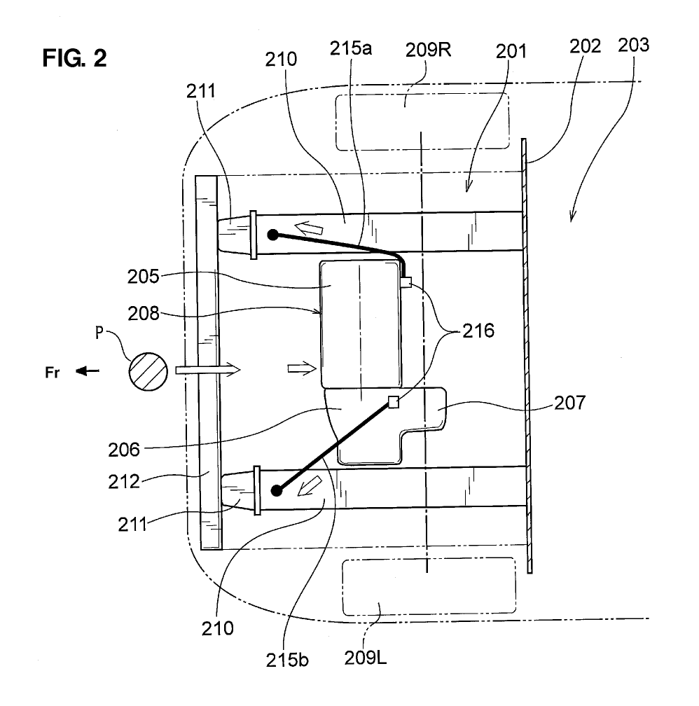

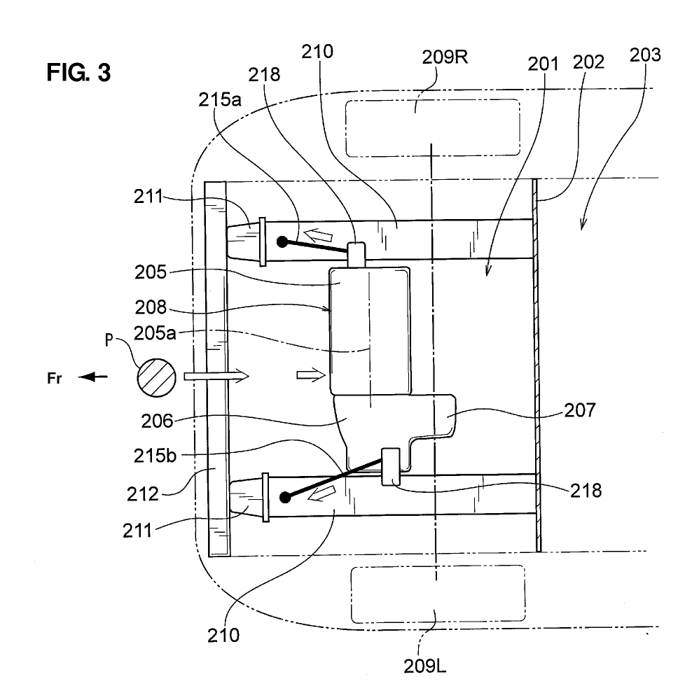

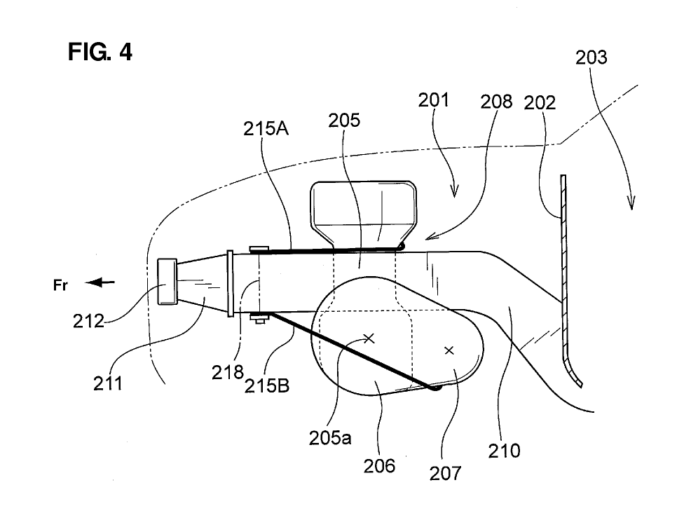

### DETAILED DESCRIPTION OF THE INVENTION

Hereinafter, preferred embodiments of the present invention will be described referring to the accompanying drawings.

### Embodiment 1

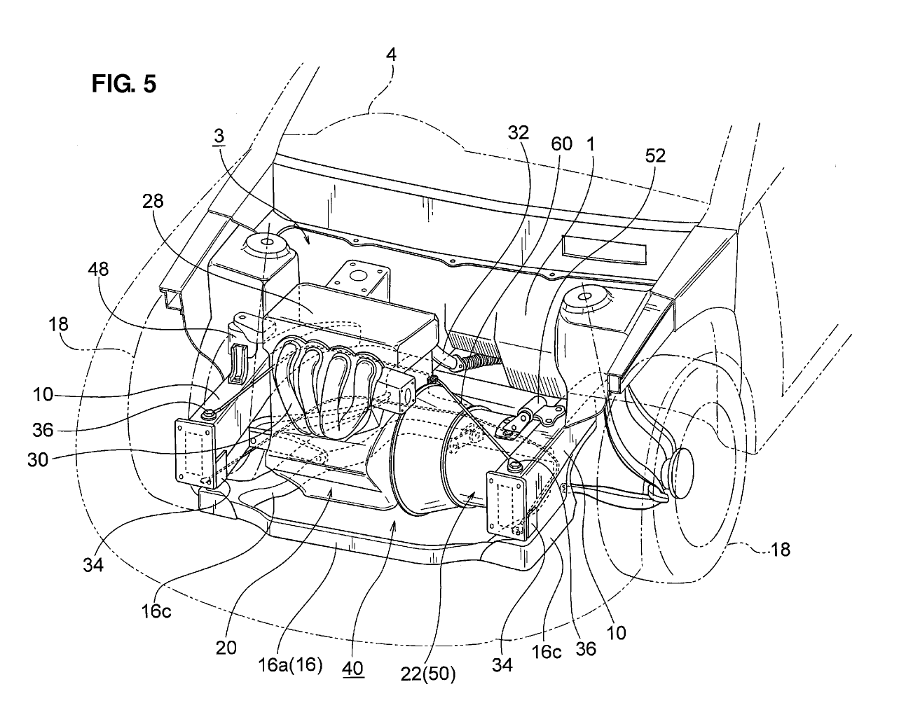

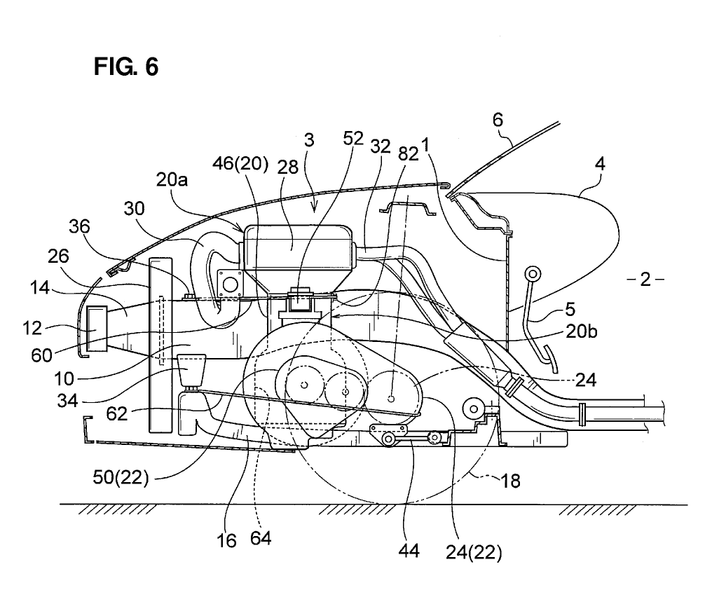

A first embodiment will be described referring to FIGS. 5 through 11. A reference numeral 1 denotes a dash panel, which partitions a vehicle compartment 2 from an engine room 3. An instrument panel 4, a brake pedal 5, an accelerator pedal and the like are provided in the vehicle compartment 2. A reference numeral 6 denotes a windshield. FIG. 5 is a view of the engine room 3, when viewed obliquely from above. FIG. 6 is a view of the engine room 3, when viewed from side. A pair of right and left front side frames 10 is disposed in a lower area of the engine room 3 so as to extend in the longitudinal direction over a whole area of the engine room 3. The front side frames 10 have a rectangular structure with a closed cross section. A bumper reinforcement 12 which extends in the vehicle width direction is connected to a front end of the front side frames 10 via crash cans 14, which is as known. In FIG. 5, the engine room 3 is illustrated, omitting illustrations of the bumper reinforcement 12 and the crash cans 14. A sub frame 16 is also disposed in the lower area of the engine room 3 at a position below the front side frames 10. A reference numeral 18 denotes a front wheel.

An engine 20, a water-cooling four-cylinder inline engine, is disposed in the engine room 3 in such a manner that an engine output shaft is disposed in the vehicle width direction (FIG. 5). That is, the engine 20 is a lateral disposition type of reciprocating engine. A transaxle 22 is coupled to a rear end of the engine 20, the engine and the transaxle 22 are disposed in the vehicle width direction, and the engine output is distributed to the both front wheels 18 via a differential gear 24 which is stored inside the transaxle 22. This automotive vehicle is a front-wheel drive type of vehicle, but the present invention is applicable to a four-wheel drive type of vehicle as well. The engine 20 is a water cooling type of engine, in which a coolant of the engine 20 is cooled by a radiator (not illustrated) which is fixed to a shroud panel 26 disposed between both-side front end portions of the front side frames 10.

In the lateral disposition type of engine 20, the air intake is conducted from its front face 20a, and the gas exhaustion is conducted from its rear face 20b. That is, this engine 20 adopts the front air intake and the rear gas exhaustion (FIG. 6), so an intake pipe 30 is connected to a front face of a cylinder head 28 and an exhaust pipe 32 is connected to a rear face of the cylinder head 28. The sub frame 16 is comprised of a substantially square perimeter frame which includes front and rear portions 16a, 16b which respectively extend in the vehicle width direction between front ends and rear ends of the both-side front side frames 10, and right and left side portions 16c which respectively extend along the both-side front side frames 10.

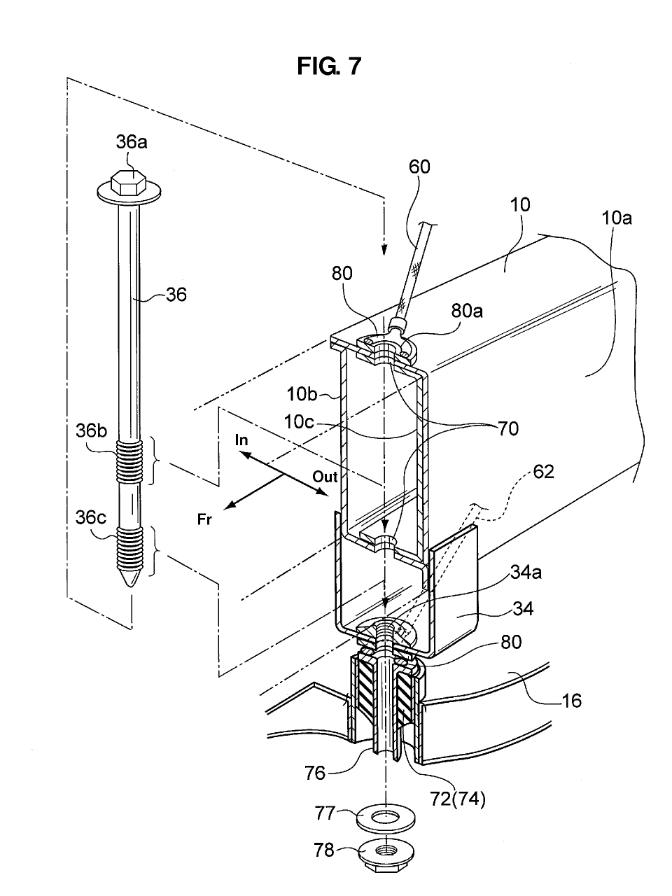

Referring to FIG. 6, at a front end portion of the front side frames 10 are provided brackets 34 for the perimeter frame which extend downward. The sub frame 16 is fixed to lower ends of the brackets 34 for the perimeter frame via long bolts 36 (FIGS. 5 and 7).

A power plant 40 which includes the engine 20 and the transaxle 22 is mounted in the engine room 3 via a first mount member 44, a second mount member 48, and a third mount member 52. Herein, the first mount member 44 is disposed between a rear portion 16b of the sub frame 16 and a lower face of a case 42 of the differential gear 24. The second mount frame 48 is disposed between an upper face of one of the front side frames 10 and a cylinder block 46. The third mount member 52 is disposed between an upper face of the other of the front side frames 10 and an upper face of a transmission case 50 of the transaxle 22.

Herein, an upper wire 60 and a lower wire 62, which are comprised of a single wire respectively, are provided between the front side frames 10 and the power plant 40. The upper wire 60 extends behind the engine 20 at a position between the cylinder block 46, i.e., a crank case 64, and the cylinder head 28, and then extends forward. Both-side front ends of the upper wire 60 are respectively coupled to upper ends of the long bolts 36 which penetrate the front side frames 10.

Meanwhile, the lower wire 62 extends behind the crank case 64, the differential gear case 42, and the transmission case 50, and then extends forward. Both-side front ends of the lower wire 62 are respectively coupled to lower ends of the long bolts 36 which penetrate the front side frames 10. Thus, the front ends of the both wires 60, 62 are coupled to the front end portions of the front side frames 10 by using the long bolt 36 which attaches the sub frame 16 to the front side frames 10. Herein, it may be preferable that the front end portions of the front side frames 10 be reinforced with reinforcements.

FIG. 7 shows a specific example of the coupling of the front ends of the upper and lower wires 60, 62 to the front side frames 10. The front side frame 10 is comprised of an outer 10a and an inner 10b which form a structure with a vertically-long closed cross section. Inside this closed cross section structure is provided a reinforcement 10c with a U-shaped cross section. The upper and lower walls of the front side frame 10 and the reinforcement 10c have bolt through holes 70. The long bolt 36 is inserted into the bolt holes. Further, a bracket 34 which extends downward is welded to the front end portion of the front side frame 10, and the sub frame 16 is provided at a lower end face of the bracket 34. The long bolt 36 extends vertically so as to fix the sub frame 16 to the front side frame 10. This long bolt 36 has a bolt head 36a and first and second threads 36b, 36c at its lower end portion. Meanwhile, the front side frame 10 has the bolt through holes, and the bracket 34 has a thread 34a which is to engage with the first thread 36b of the long bolt 36. A mount member 74 with a rubber bush 72 is fixed to the sub frame 16. The mount member 74 has a center sleeve 76 which extends vertically.

As apparent from FIG. 7, the front ends of the upper and lower wires 60, 62 have terminals of single locks 80, respectively. Each single lock 80 has an eye 80a into which the long bolt 36 is inserted. A nut 78 is fastened to the long bolt 36 with a large-diameter washer 77, so that the upper and lower wires 60, 62 are coupled to the front side frames 10. Herein, the front end of the upper wire 60 is disposed at the upper face of the front side frame 10, and the front end of the lower wire 62 is disposed between the bracket 34 and the sub frame 16.

When the impact load is inputted to the front side frames 10 via the upper and lower wires 60, 62, since the specified portion of each of the front side frames 10 where the impact load is inputted is reinforced by the reinforcements 10c, the impact load is dispersed to the three sides of the four sides of the closed cross section of the front side frame 10 by the reinforcement 10c. Accordingly, the front side frames 10 crash effectively, so that the front side frames 10 can perform the shock absorbing function properly. Further, since the impact load is inputted to the front side frames 10 with the vertically-long closed cross section structure via the upper and lower wires 60, 62 and the long bolts 36 which penetrate the front side frames 10 vertically. In other words, compared to a case in which the long bolts 36 are provided so as to penetrate the front side frames 10 laterally (horizontally), the bolt through holes 70 and the corner portions of the front side frame 10 are located so close to each other that the portion around the bolt through holes 70 can be prevented from being broken or cracked (torn). Accordingly, the impact load inputted from the long bolts 36 can be transmitted to the front side frames 10 effectively.

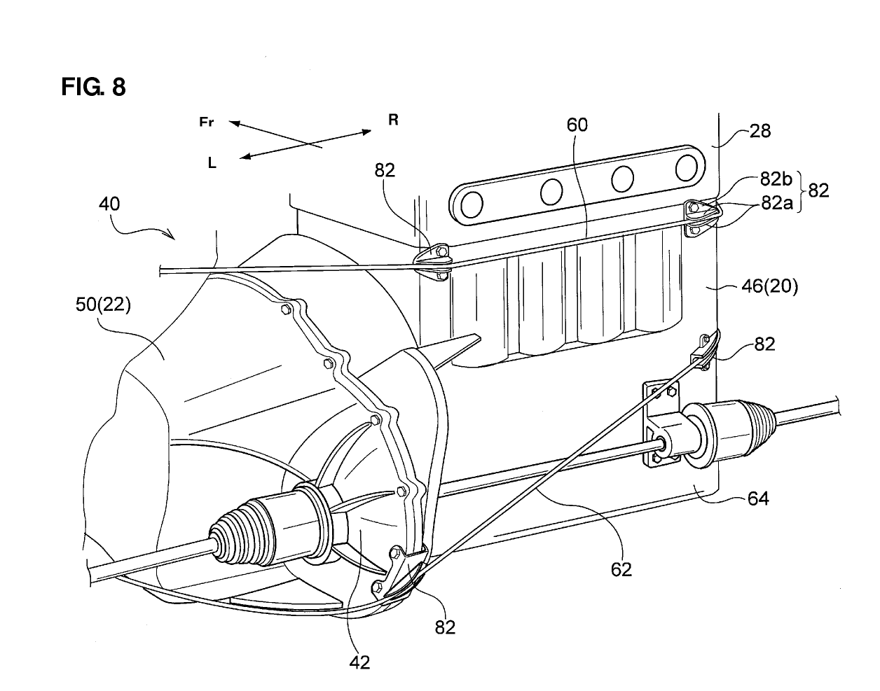

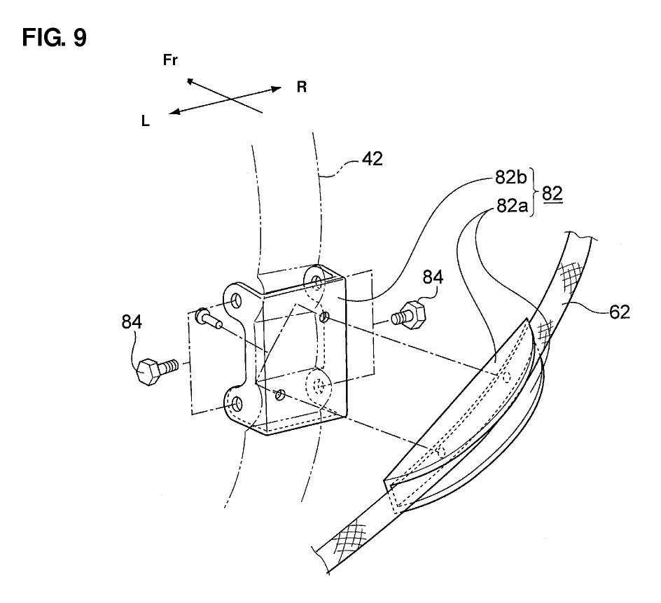

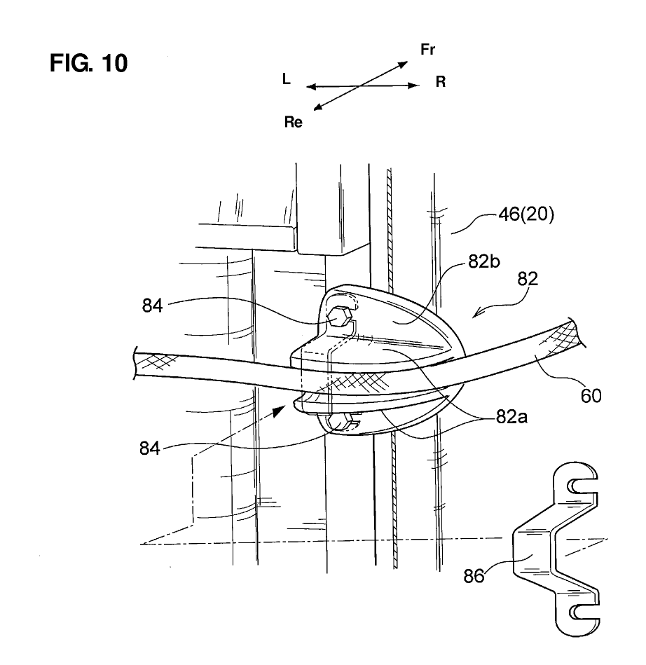

The layout of the upper and lower wires 60, 62 is positioned by guide members 82 as apparent from FIG. 8. The guide member 82 has two walls 82a, and each wire of the wires 60, 62 is positioned between these walls 82a. The walls 82 may be formed integrally with a body 82b of the guide member 82, or these are formed separately as shown in FIG. 9. The guide member 82 is fixed to the power plant 40 with a bolt 84. It may be preferable that the guide member 82 be covered with a cap 86 (FIG. 10) after setting the upper or lower wire 60, 62. Thereby, the wires 60, 62 can be prevented from being detached off the guide member 82 during the move of the power plant 40.

The upper wire 60 extends behind the upper end portion of the cylinder block 46 of the engine 20, and its one end extends forward along a front end face of the engine, an opposite end face to the transaxle 22, while its other end extends forward above the transaxle 22. Both front ends of the upper wire 60 are coupled to the front end portions of the both front side frames 10. The upper wire 60 is, as apparent from FIG. 6, positioned substantially in parallel to the axis line of the front side frame 10. Meanwhile, the lower wire 62 extends behind the transaxle 22 and the crank case 64, and its both ends extend forward and are fixed to the portion between the bracket 34 at the front end portion of the front side frame 10 and sub frame 16. The lower wire 62 is positioned so as to extend in a lower area below the engine output shaft 20c (FIG. 6).

When the vehicle frontal collision occurs, the obstacle, such as the pole, collides with a central portion of the bumper reinforcement 12, the bumper reinforcement 12 bends at this central portion, and this obstacle comes into the engine room 3 and then hits against the power plant 40, this impact load can be properly dispersed to the front end portions of the front side frames 10 via the upper and lower wires 60, 62. Herein, since the front side frames 10 originally have the shock absorbing function against the general vehicle frontal collision, the impact load which is caused by the above-described collision with the pole-shaped obstacle via the wires 60, 62 can be absorbed properly by the front side frames 10. Further, the power plant 40 can be suppressed by the wires 60, 62 from moving rearward.

Of course, the above-described advantage of the impact load absorption can be achieved without applying any particular change to the basic structure design against the full-lap frontal collision or the offset frontal collision. Further, the rearward move of the power plant 40 can be properly received by the upper and lower wires 60, 62, so that the rotation of the power plant 40 in the side view can be suppressed. Thereby, the input of the impact load to the front side frames 10 via the wires 60, 62 can be made properly prompt.

Further, since the upper and lower wires 60, 62 are couplet to the front side frames 10 via the long bolts 36 which penetrate the front side frames 10 for fixing the sub frame 16, not only any other particular member for coupling the front ends of the wires 60, 62 to the front side frames 10 may not be necessary, but the impact load can be dispersed to the sub frame 16 as well as the front side frames 10.

Moreover, since the structure of fixing the wires 60, 62 to the front side frames 10 by using the member (long bolt 36) which penetrates the front side frame 10 with the closed cross section is applied, the impact load from the wires 60, 62 can be dispersed to both of the upper and lower faces of the front side frames 10. Thereby, any local breakage of the front side frames 10 or any unexpected deformation (crash) of the front end portions of the front side frames 10 which may be caused by the inputted load from the wires 60, 62 can be properly prevented. Accordingly, the shock absorbing function of the front side frames 10 with the original crash can be performed.

Further, since the front ends of the lower wire 62 are coupled to the portions between the brackets 34 which extend downward from the front end portions of the front side frames 10 and the sub frame 16, the disposition of the lower wire 62 below the engine output shaft 20c can be facilitated, and the lower wire 62 can be disposed substantially in parallel to the axis line of the front side frames 10. Accordingly, the direction of the impact load which acts on the front side frames 10 via the lower wire 62 can be almost in parallel to the front side frames 10. In other words, any unexpected deformation (crash) of the front side frames 10 which may be caused by any component force of the impact load can be prevented properly from occurring. Thus, the shock absorbing function of the front side frames 10 with the original crash can be performed. Of course, since the input direction to the front side frames 10 is made in parallel to the front side frames 10 by disposing the upper wire 60 so as to extend behind the upper end portion of the cylinder block 46, the shock absorbing function of the front side frames 10 with the original crash can be performed. Since the front ends of the upper and lower wires 60, 62 have the terminals of the single locks 80 which do not have any side projecting portion, the front ends of the wires 60, 62 may not interfere with the front side frames 10.

In the present invention, two wires 60, 62 may not be necessary, but only any one of wires 60 or 62 can be applied properly.

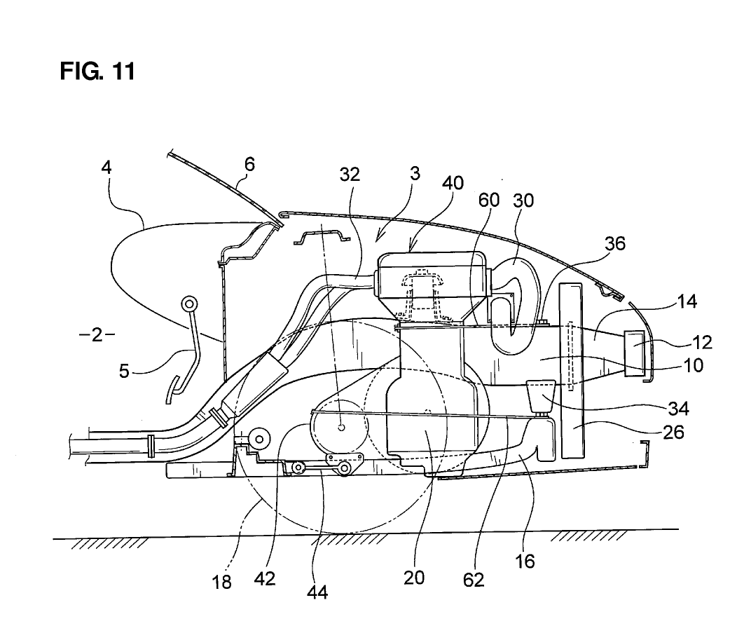

FIG. 11 shows a modified embodiment of the first embodiment. As apparent from FIG. 11, the lower wire 62 may be disposed in parallel to the axis line of the front side frames 10.

### Embodiment 2

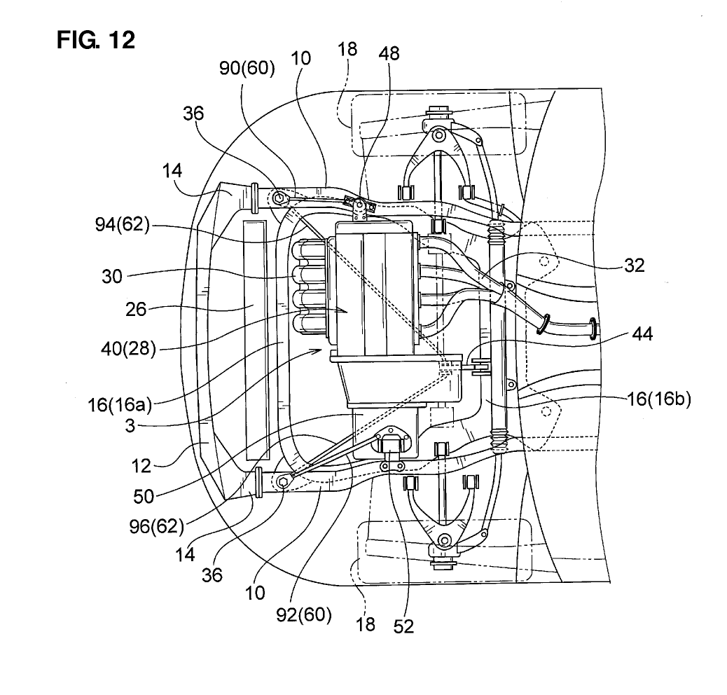

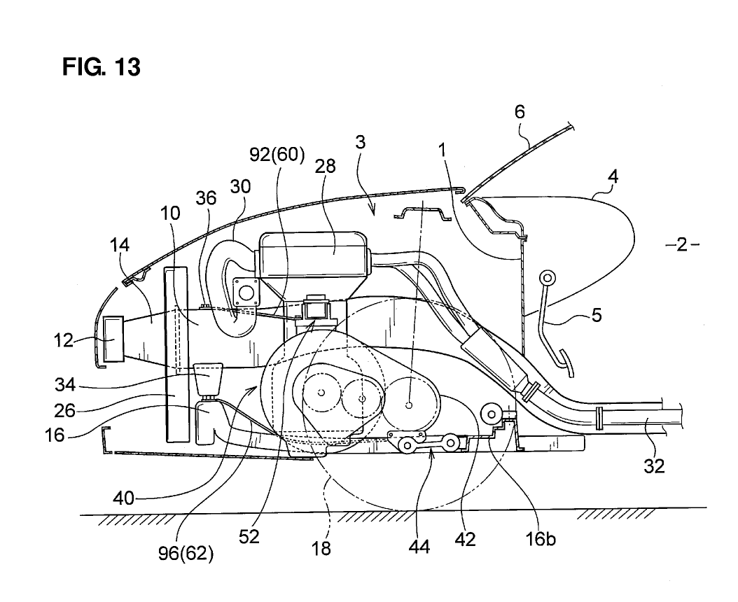

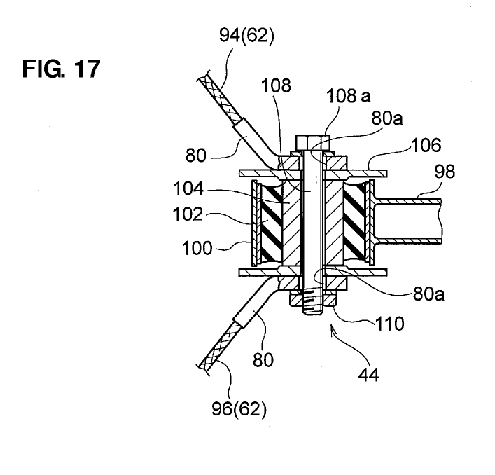

A second embodiment will be described referring to FIGS. 12 through 17. The same elements as those of the first embodiment are denoted by the same reference numerals, descriptions of which are omitted here.

The upper wire 60 is comprised of first and second split wires 90, 92. Rear ends of these are respectively coupled to second and third mount members 48, 52, thereby coupled to the power plant 40 indirectly via the mount members 48, 52. Herein, the second and third mount members 48, 52 are a rigidity member which is directly related to the power plant 40, so the power plant related to the flexible tension member according to the present invention includes the second and third mount members 48, 52.

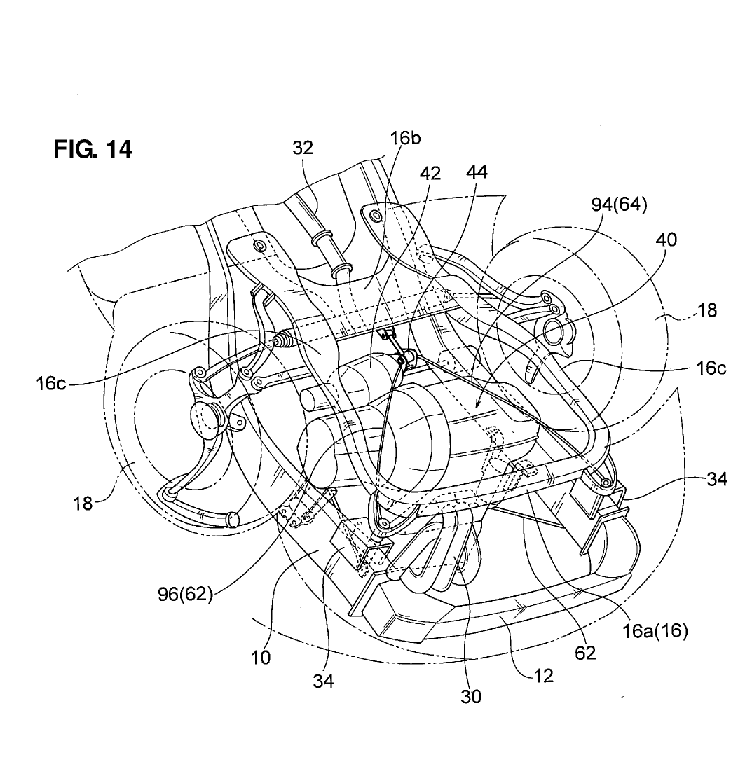

As apparent from FIG. 14 which shows a bottom view of the engine room, the lower wire 62 is comprised of first and second split wires 94, 96. These slit wires 94, 96 extend below a lower face of the power plant 40. Rear ends of these wires 94, 96 are coupled to a first mount member 44, thereby coupled to the power plant 40 indirectly via the first mount member 44. Likewise, the first mount member 44 is a rigidity member which is directly related to the power plant 40, so the power plant related to the flexible tension member according to the present invention includes the first mount member 44.

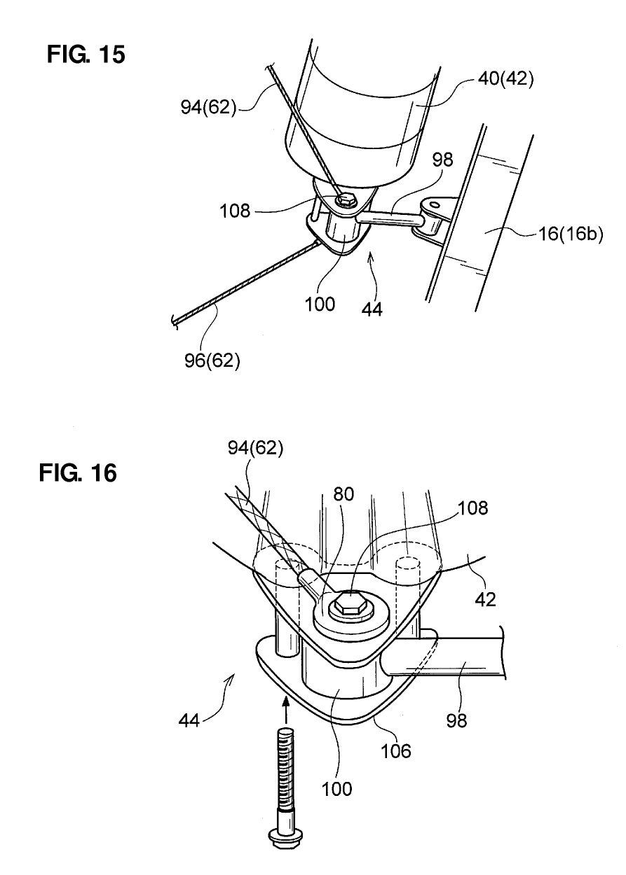

FIGS. 15 through 17 are specific views of the first mount member 44. The first mount member 44 has a sleeve 100 at a tip of a swing arm 98 which extends forward from a rear portion 16b of the sub frame 16. The sleeve 100 is connected to an axis portion 104 via a rubber 102. The axis portion 104 is fixed to a bracket 106 which is connected to the power plant 40 with a bolt 108 and a nut 110. Rear ends of the first and second split wires 94, 96 have the single locks 80. The bolt 108 is inserted into the eyes 80a (FIG. 16) of the single locks 80. Thereby, the rear ends of the first and second split wires 94, 96 are coupled to the power plant 40 via the first mount member 44. Herein, it may be preferable that the rear end of one of the wires 94 be disposed near a bolt head 108a, and the rear end of the other 96 be disposed near the nut 110 as apparent from FIG. 12.

According to the second embodiment, the lower wire 62 is disposed in a V shape along the lower face of the power plant 40 as shown. Thereby, the rearward move of the power plant 40 can be received properly and also the rotation of the power plant 40 in the side view can be suppressed. Accordingly, the delay of input of the impact load to the front side frames 10 via the lower wire 62 can be prevented. While the both of the upper and lower wires 60, 62 are comprised of two split wires in the second embodiment, one of those may be comprised of two split wire, and the other may be comprised of a single wire as described in the above-described first embodiment.

### Embodiment 3

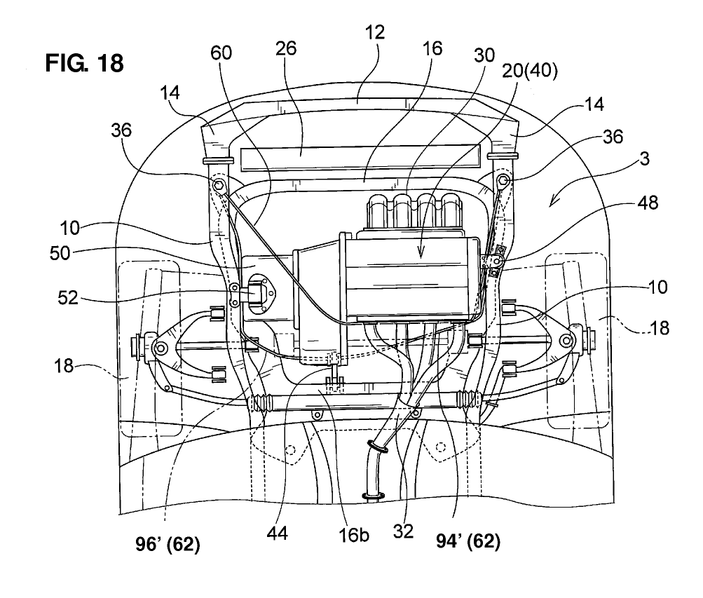

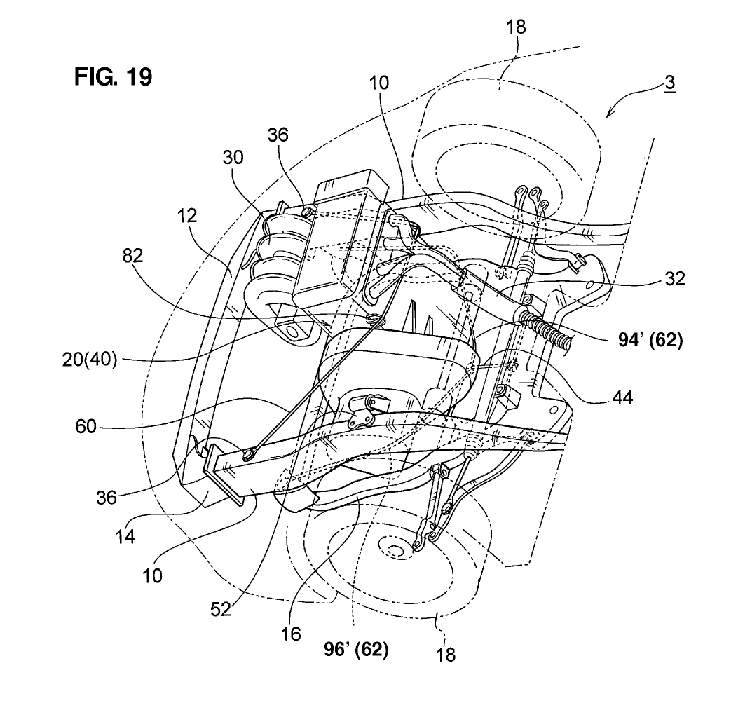

A third embodiment will be described referring to FIGS. 18 and 19. The same elements as those of the above-described embodiments are denoted by the same reference numerals, descriptions of which are omitted here.

In the third embodiment, the upper wire 60 is comprised of the single wire like the above-describe first embodiment and disposed in parallel to the axis line of the front side frames 10. The lower wire 62 is comprised of first and second split wires 94′, 96′ which is similar to the above-described second embodiment. The rear ends of the first and second split wires 94′, 96′ are coupled the first mount member 44 which is described above in the second embodiment.

### Embodiment 4

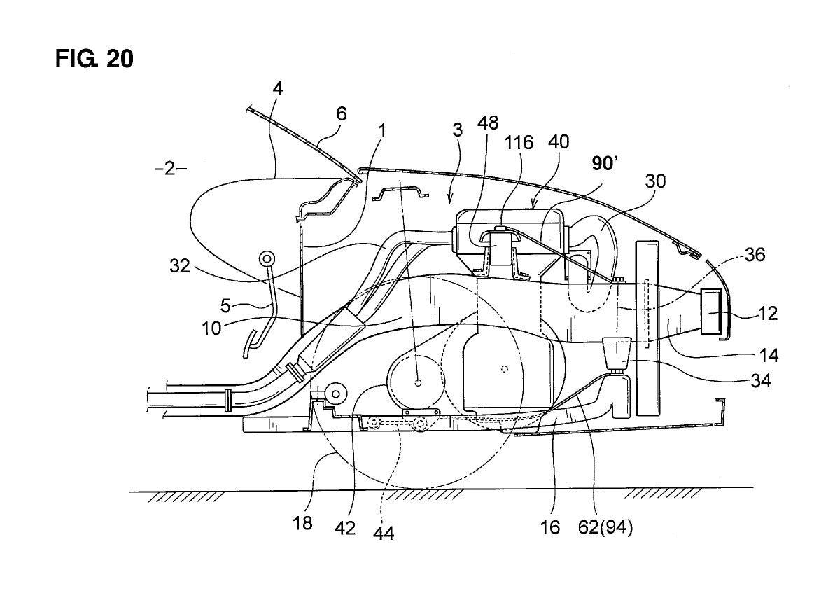

A fourth embodiment will be described referring to FIGS. 20 through 22.

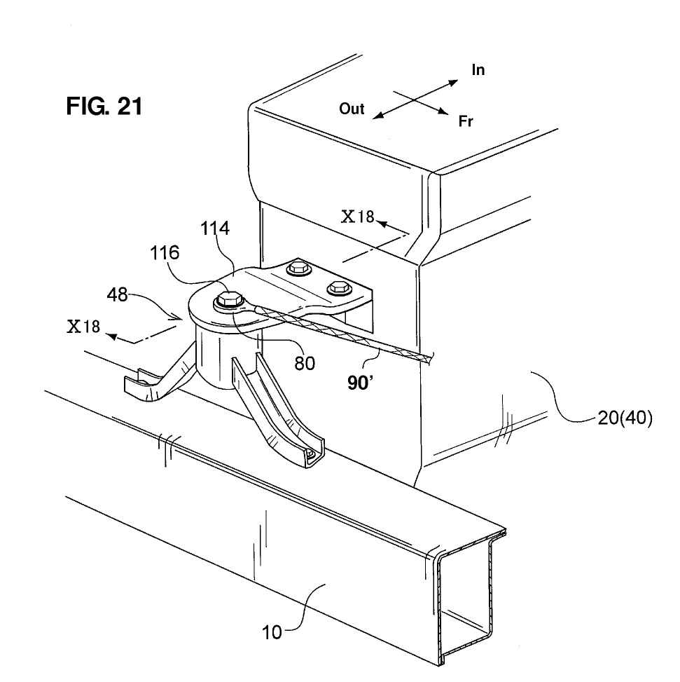

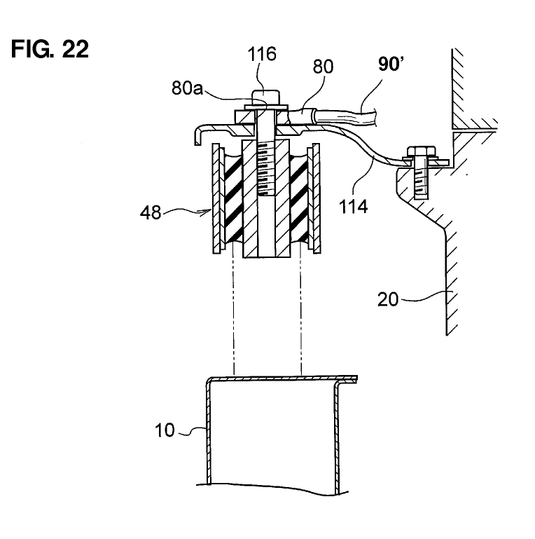

In the fourth embodiment, the upper and lower wires 60, 62 are respectively comprised of two split wires, like the above-described first embodiment. Herein, a rear end of a first upper wire 90′ is coupled to the upper end of the second mount member 48. Referring to FIG. 21 and 22, the engine 20 is mounted at the front side frame 10 via the second mount member 48 which is disposed on the upper face of the front side frame 10. A horizontal bracket 114 which is fastened by bolts to the end face of the engine 20 is attached to the second mount member 48 via a vertical bolt 116.

The rear end of the first upper split wire 90′ has the single lock 80. This single lock 80 is disposed on the horizontal bracket 114, and then fastened to the second mount member 48 by the vertical bolt 116.

### Embodiment 5

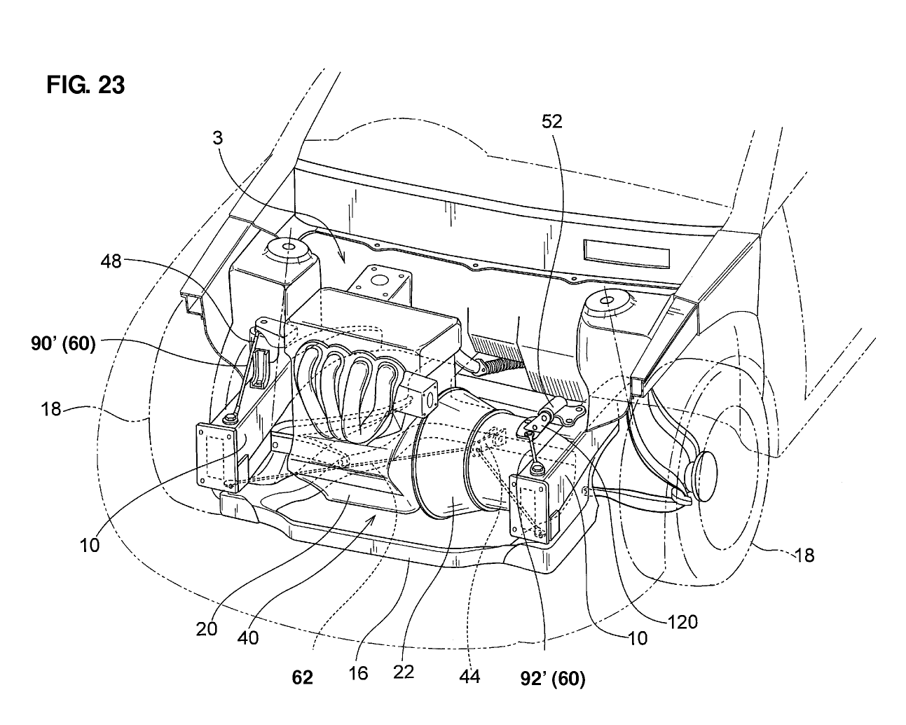

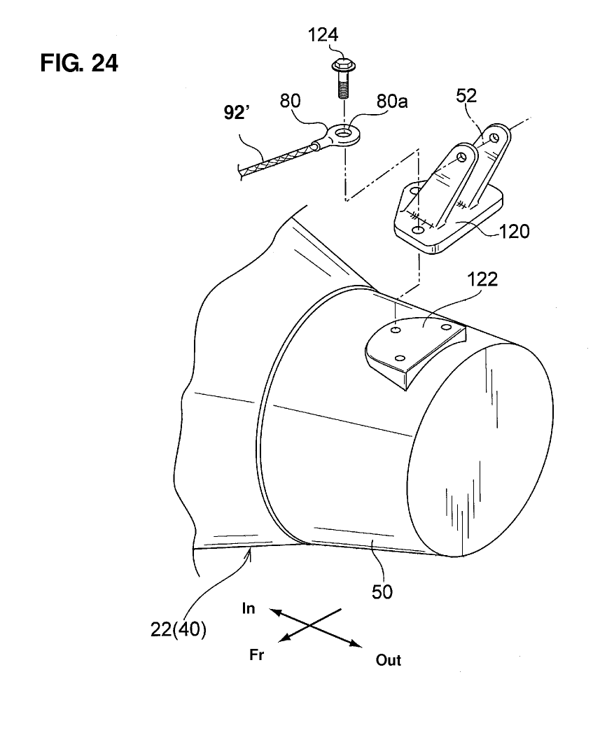

A fifth embodiment will be described referring to FIGS. 23 and 24.

In the fourth embodiment, the upper and lower wires 60, 62 are respectively comprised of two split wires, like the forth embodiment. Herein, a rear end of a second upper wire 92′ is coupled to the third mount member 52. As shown in FIG. 24, a bracket 120 is disposed on a seat 122 which is formed at the upper face of the transmission case 50 of the transaxle 22. The bracket 120 is fixed onto the seat 122 via a bolt 124. Herein, the rear end of the second upper split wire 92′ has the single lock 80. The bolt 124 is inserted into the eye 80a of the single lock 80 and then the bracket 120 is fastened onto the seat 122 of the transaxle 22. Thus, the rear end of the second upper wire 92′ is coupled to the transaxle 22 via the third mount member 52.

### Embodiment 6

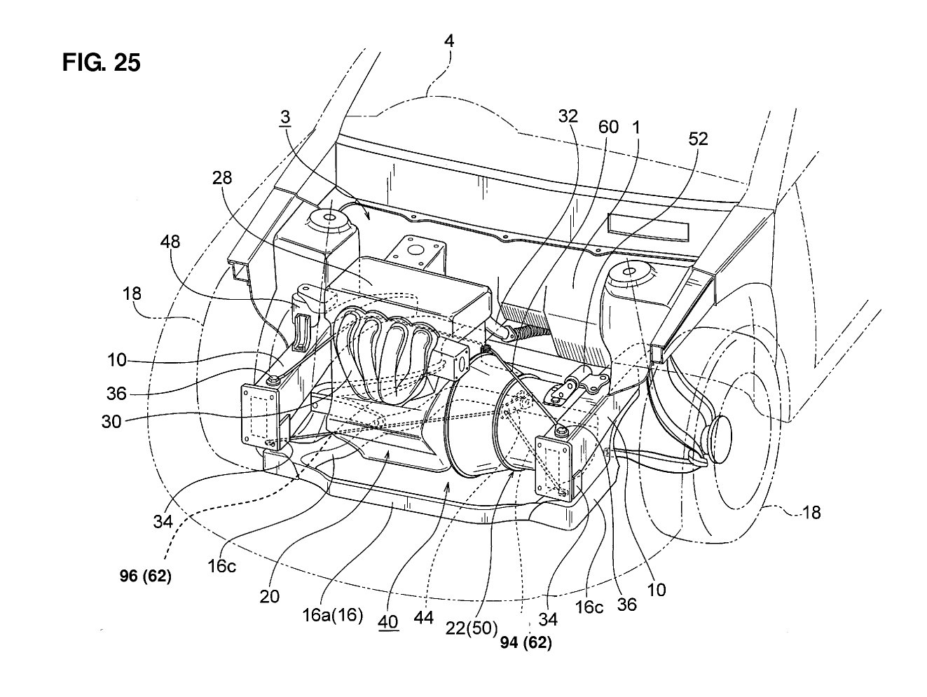

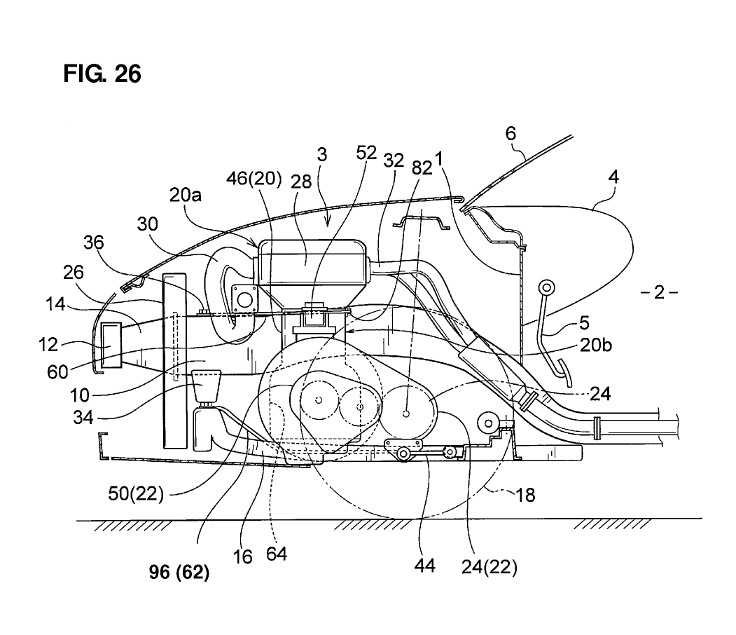

A sixth embodiment will be described referring to FIGS. 25 and 26.

In the sixth embodiment, the upper wire 60 is comprised of the single wire like the above-describe first embodiment and disposed in parallel to the axis line of the front side frames 10. The lower wire 62 is comprised of first and second split wires 94, 96 like the above-described second embodiment. The rear ends of the first and second split wires 94, 96 are coupled the first mount member 44 which is described above in the second embodiment.

The present invention should not be limited to the above-described embodiments, and any other modifications and improvements may be applied within the scope of a sprit of the present invention.

What is claimed is:

1. A front vehicle body structure, comprising:
a power plant provided in an engine room;
a pair of front side frames provided at both sides of a vehicle body, which extends in a longitudinal direction of the vehicle body; and
a flexible tension member provided between the pair of front side frames and the power plant, respective front ends of which are coupled to front end portions of the pair of front side frames.

2. The front vehicle body structure of claim 1, wherein said flexible tension member comprises a single tension member, both ends of which are coupled to the front end portions of said pair of front side frames, and the single flexible tension member extends behind the power plant.

3. The front vehicle body structure of claim 1, wherein said flexible tension member comprises first and second split tension members which are separate from each other and positioned on both sides of the power plant, respective front ends of which are coupled to front end portions of the pair of front side frames and respective rear ends of which are coupled to the power plant directly or indirectly.

4. The front vehicle body structure of claim 3, wherein the rear ends of said first and second split tension members are respectively coupled to said power plant.

5. The front vehicle body structure of claim 3, wherein the rear ends of the first and second split tension members are respectively coupled to mount members of said power plant, said power plant being mounted at said front side frames directly or indirectly via the mount members.

6. The front vehicle body structure of claim 3, wherein a rear end of one of said first and second split tension members is coupled to said power plant and a rear end of the other of the first and second split tension members is coupled to a mount member of said power plant, said power plant being mounted at said front side frame directly or indirectly via the mount member.

7. The front vehicle body structure of claim 1, wherein said flexible tension member comprises two sets of flexible tension members which are respectively positioned on an upper side and a lower side of the vehicle body, each set of which is provided between the pair of front side frames and the power plant, and respective front ends thereof are coupled to front end portions of the pair of front side frames.

8. The front vehicle body structure of claim 7, wherein said two sets of flexible tension members comprise a single tension member, respectively, both ends of which are coupled to the front end portions of the pair of front side frames, and each flexible tension member extends behind the power plant.

9. The front vehicle body structure of claim 7, wherein said upper-side positioned flexible tension member comprises a single tension member, both ends of which are coupled to the front end portions of the pair of front side frames, the single flexible tension member extends behind the power plant, and said lower-side positioned flexible tension member comprises first and second split tension members which are separate from each other and positioned on both sides of the power plant, respective front ends of which are coupled to front end portions of the pair of front side frames and respective rear ends of which are coupled to the power plant directly or indirectly.

10. The front vehicle body structure of claim 7, wherein said two sets of flexible tension members comprise first and second split tension members, respectively, which are separate from each other and positioned on both sides of the power plant, respective front ends of which are coupled to front end portions of the pair of front side frames and respective rear ends of which are coupled to the power plant directly or indirectly.

11. The front vehicle body structure of claim 7, wherein said pair of front side frames has a closed cross section, said lower-side positioned flexible tension member is coupled to a rear end portion of said power plant, and the lower-side positioned flexible tension member extends in substantially V shape in a plan view.

12. The front vehicle body structure of claim 7, further comprising a sub frame which extends in the vehicle width direction between rear end portions of said pair of front side frames, and a first mount member which mounts a rear end portion of the power plant at the sub frame, wherein said lower-side positioned flexible tension member comprises first and second split tension members which are separate from each other and positioned on both sides of the power plant, respective front ends of which are coupled to front end portions of the pair of front side frames and respective rear ends of which are coupled to said first mount member.

13. The front vehicle body structure of claim 12, further comprising second and third mount members which mount the power plant at the pair of front side frames, respectively, wherein said upper-side positioned flexible tension member comprises first and second split tension members which are separate from each other and positioned on both sides of the power plant, respective rear ends of which are coupled to the second and third mount members, respectively.

14. The front vehicle body structure of claim 1, wherein said flexible tension member extends substantially in parallel to an axis line of the front side frames in a side view of the vehicle body.

15. The front vehicle body structure of claim 14, wherein said flexible tension member comprises two sets of flexible tension members which are respectively positioned on an upper side and a lower side of the vehicle body, each set of which is provided between the pair of front side frames and the power plant, respective front ends thereof are coupled to front end portions of the pair of front side frames, and at least one of said two sets of flexible tension members extends substantially in parallel to the axis line of the front side frames in the side view of the vehicle body.

16. The front vehicle body structure of claim 1, wherein at least one of the front ends of said flexible tension members is coupled to the front end portion of the front side frame via a long bolt which penetrates through the front end portion of the front side frame having a closed cross section.

17. The front vehicle body structure of claim 16, wherein said flexible tension member comprises two sets of flexible tension members which are respectively positioned on an upper side and a lower side of the vehicle body, each set of which is provided between the pair of front side frames and the power plant, respective front ends thereof are coupled to front end portions of the pair of front side frames, and said long bolt is provided so as to penetrate through at least one of the front end portions of the front side frames in such a manner that at least one side of the front ends of said upper-side positioned flexible tension member and said lower-side positioned flexible tension member are coupled to the front end portion of the front side frame via an upper portion of the long bolt and a lower portion of the long bolt, respectively, the upper potion of the long bolt projecting upward from an upper face of the front side frame, the lower portion of the long bolt projecting downward from a lower face of the front side frame.

18. The front vehicle body structure of claim 16, wherein at least one of the front ends of said flexible tension members has a ring-shaped terminal portion, and said long bolt is provided so as to penetrate through the ring-shaped portion and the front end portion of the front side frame, whereby at least one of the front ends of the flexible tension members is coupled to the front end portion of the front side frame via the long bolt.

19. The front vehicle body structure of claim 1, wherein said power plant comprises a multi-cylinder reciprocating engine, and said flexible tension member is positioned at a level which substantially corresponds to a specified portion between a crank case and a cylinder head of the engine
